(19) United States
(12) Patent Application Publication
(10) Pub. No.: US 2013/0085881 A1
(43) Pub. Date: Apr. 4, 2013

(54) Mobile and Web Commerce Platform for delivery of Business Information and Service Status Management.

(71) Applicants: Srimannarayana Chary, Westford, MA (US); Ramesh Joginpalli, Nashua, NH (US); Rohinton Gonda, Pepperell, MA (US); Ramesh Bapanapalli, Woburn, MA (US)

(72) Inventors: Srimannarayana Chary, Westford, MA (US); Ramesh Joginpalli, Nashua, NH (US); Rohinton Gonda, Pepperell, MA (US); Ramesh Bapanapalli, Woburn, MA (US)

(73) Assignee: PANZARA INC., Nashua, NH (US)

(21) Appl. No.: 13/621,282

(22) Filed: Sep. 16, 2012

Related U.S. Application Data
(60) Provisional application No. 61/542,198, filed on Oct. 1, 2011.

(51) Int. Cl. G06Q 30/00

(52) U.S. Cl. 705/26.1

(57) ABSTRACT

Described in this invention are the methods and system platform for businesses and organizations to publish and communicate to consumers business information and real-time dynamic service information in a central and intuitive place on mobile devices and computers that is based on a generic, configurable, extensible, and vendor-independent mobile-commerce and electronic-commerce cloud based Software as a Service solution. The consumer and service providers use mobile device application client software and computer-based web browser client application software that are part of the platform solution to access and manage the information stored on the platform. The platforms allow service providers to perform functions such as: publish business information, real-time dynamic service status information, manage loyalty programs, manage customer marketing programs, and take online reservations. The platform allows consumers to perform functions such as: search for the business or service near a geo-location, obtain for the above-mentioned information, and subscribe for the programs.

### CROSS-REFERENCE TO RELATED APPLICATIONS

This application claims priority to the U.S. Provisional Application identified by Ser. No. 61,542,198 filed on Oct. 1, 2011, the disclosure of which is incorporated by reference herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### FIELD OF THE INVENTION

The present invention is in the field of mobile-commerce and electronic-commerce with Software-as-a-Service, and more particularly, to methods and system for the management and location-based delivery of business or organization information and real-time dynamic service status information to individual and business consumers via the mobile devices and over the communications network.

### BACKGROUND OF THE INVENTION

Providing up-to-date Business or Organization Service Status and Event Status information to customers and consumers is a critical problem to be solved given the value of time and effort associated with modern life styles and the availability of the state of the art technologies such as the internet and mobile devices.

Today, there is no central and intuitive place on mobile devices or web for consumers to find real-time dynamic business or service status information to choose the best service provider. For example, to pick a service provider that is close by, with available capacity, with the shortest wait time, and with deals or loyalty programs of interest.

Currently the internet search engines are limited to replying with a static list of service providers and any Service Status information if available on a obscure page of the service provider's web site or service provider specific mobile applications requiring consumer to download an application for each service provider or having to go to a web page on their web site.

On the mobile devices front there are too many applications from service providers that are specific point solutions for each individual service provider leaving the customer with having to download and keep many applications on their mobile device and use each of them separately when needed. These individual service provider point applications are designed to solve a specific problem and collectively leave many holes in providing comprehensive solution to both—consumer's activities as well as service providers.

Many service providers do not even provide this information online for consumers due to lack of IT expertise and infrastructure. For them, the only way the consumer could find this information is by calling the provider or going there in person and getting in the queue.

Business services being delayed or there being long wait times can leave the customer unsatisfied. Some examples of service providers where business can improve the situation by communicating better are listed below. Some of these businesses and organizations do provide some of this information, however, as mentioned above these are very specific point solutions.

Some examples of market verticals that will benefit from this solution are listed below. This is only a small subset listed for illustration purposes. The solution applies to all businesses that want to provide up-to-date service status information to their customers.
(1) Hospitals can provide wait times and delays for Emergency Room.
(2) Restaurants can provide wait time and also allow making reservations.
(3) Banks can provide the delay associated with teller service by indicating how much the service is backed up. Consumer can take a look at banks in the near vicinity using this application and decide whether to go now to avail the service or postpone the trip. This will save consumer's time as well as eliminate rush at the bank.
(4) Transportation Security Authority (TSA) post the delay times at various airport terminals.
(5) State Departments of Transportation (State DOT) providing delay time at various toll bridges. This allows commuters to plan their commute route appropriately.
(6) Airport Security wait-times.
(7) Theme park applications are provide wait time at various rides in the theme park. This allows vacationers to go to the one with the shortest wait times.

Similarly persons attending large events can get frustrated when the program is running late or is changing and they are not able to better plan their schedule for attending due to lack of communication of the changes. Organizers of such events can also use this platform to provide up-to-date information to their event participator.

Accordingly there is a need for methods and system for providing a mobile and web commerce platform for delivery business and organization information and the service status information to individual and business consumers via the mobile devices, the web, and over the communications network, that overcome limitations with the existing art not expressly mentioned above.

### SUMMARY OF THE INVENTION

The present invention provides methods and system for businesses and organizations to communicate real-time dynamic information about service status to individual customers and businesses that are consumers of that information in a central and intuitive location on the internet with access via mobile devices and the internet that is based on a generic and vendor-independent mobile-commerce and electronic-commerce cloud based Software as a Service (SaaS) solution, thus overcoming the limitations with the existing art.

In one aspect of the invention, a platform for the management and delivery of business or organization information and service status information to individual and business consumers by business, service providers, event organizers, etc. The consumer can use it to search for business, services, events, etc. based on a search criteria or keyword and location. Uniquely the search results show the real-time dynamic status information for the business. After finding the service the consumer can select a service to see more details about the current real-time service status like wait-time, availability, etc. and service information like address, phone number, web site, directions, commute time, menu, floor plans, coupons, punch cards, point cards, etc. The detailed service information also allows consumer to set up appointments, get in the queue with a number token, etc. The service provider can use it to publish service status information, update the service status information as needed at any point in time, set up an account.

In an embodiment, the platform comprises of client-server architecture where the platform client software is a mobile application running on mobile devices like iPhone, iPad, Android device, Windows device, Blackberry, etc. and/or a personal computer-based application running within a browser like Firefox, Internet Explorer, Safari, Opera, etc. The platform server software consists of the Web Server, Application Server, and Database Management Software, running on the internet cloud. The platform implements functionality for consumers and service providers.

These and other objects, features, and advantages of the present invention will become apparent from the following detailed description of illustrative embodiments thereof, the accompanying drawings, and the claims.

### BRIEF DESCRIPTION OF THE DRAWINGS

The advantages of the invention described together with further advantages, will be better understood by referring to the following description taken in conjunction with the accompanying drawings. The drawings are not necessarily to scale, emphasis generally being placed upon illustrating the principles of the invention.

FIG. 1 is a diagram illustrating the use of the mobile-commerce and electronic-commerce platform by Consumers to access real-time Business Service Status Information and by the Service Provider to publish it.

FIG. 2 is a diagram illustrating the system architecture for the platform for managing and delivery of Business or Organization information and service status information according to an embodiment of the present invention.

FIG. 3 is diagram illustrating portions of the mobile device client application of the platform used by consumer to search and access the information and service providers to update the information according to an embodiment of the present invention.

FIG. 4 is a diagram illustrating portions of the computer web browser client application of the platform used by consumer to access the search results summary information according to an embodiment of the present invention.

FIG. 5 is a diagram illustrating portions of the computer web browser client application of the platform used by consumer to access the detailed status and other business information according to an embodiment of the present invention.

FIGS. 6A, 6B, 6C, and 6D, are a flowchart illustrating an example scenario of the consumer access of information operations of the service status information management system according to an embodiment of the present invention.

FIGS. 7A and 7B is a flowchart illustrating an example scenario of the service provider provisioning organizational information operations of the service status information management system according to an embodiment of the present invention.

FIGS. 8A and 8B is a flowchart illustrating an example scenario of the service provider provisioning administrative and user group information operations of the service status information management system according to an embodiment of the present invention.

FIG. 9 is a flowchart illustrating an example scenario of the service provider update of the service status information operations of the service status information management system according to an embodiment of the present invention.

### DETAILED DESCRIPTION OF THE INVENTION

The present invention will be explained below in the context of an illustrative platform system architecture and framework for supporting mobile-commerce and electronic commerce for the management and delivery of business or organization information and service status information. Particularly, the management and delivery methodologies of the invention will be explained in the context of this architecture and framework. However, it is to be appreciated that the invention is not limited to any particular business information management and delivery platform architecture and is more generally applicable to any management and delivery of business or service status information to individual and business consumers via the internet world-wide-web or mobile devices.

One main motivating factor for the mobile-commerce and electronic-commerce management platform is to provide service providers, for example, service businesses, retail businesses, event organizers, government public sector services like RMV, DOT, etc., to be able to provide service status information and loyalty programs to their customers, for example, end users, consumers, other businesses, commuters, citizens, etc.

Some of the benefits that the consumers who utilize the system realize may include:
(1) Ultimate convenience of a single intuitive mobile application and web page to search for the service they want with the most up-to-date Service Status information displayed.
(2) Effectively search for services based on selected criteria.
(3) Will be able to monitor service status including wait time instead of constantly checking.
(4) Be able to see the business' typical wait time profile for the week (Signature Wait Pattern)
(5) Will be able to subscribe to loyalty programs.
(6) Make reservations/appointments with any service provider.
(7) Maintain a list of commonly used services for easy access using Bookmark or Find and Follow a Service, in their electronic and mobile wallet organizer.
(8) Form groups for social networking to communicate with several users and services easily.

Some of the benefits that the service providers who utilize the system realize may include:
(1) Become visible to many prospective consumers including roaming mobile consumers.
(2) System will function as a very effective advertisement tool.
(3) New businesses need not purchase expensive solutions when this system is available in the Cloud.
(4) Provide service status to all the consumers without being interrupted from the work.
(5) Encourage customers to come at low peak time by providing wait time, coupons, or sales.
(6) Easily make appointments/reservations without having to purchase and maintain a system.
(7) Easily manage loyalty programs and deals programs comprising of: punch cards, point cards, coupons.
(8) Easily manage customer marketing by categorizing customer user groups and targeting deals or loyalty programs to them.
(9) Generic, configurable, and extensible implementation allows easy expansion of the services.
(10) Very easy to interact with customers anywhere, thus provide means to expand businesses.
(11) Analytics to study customer patterns and preferences.

While each benefit of the platform may have some competing solutions in the market there is no single application that can match the functionality of this platform. Even the combined benefit of several applications will come short of the benefits offered by the platform because it has new, unique, and non-obvious combination.

The generic and scalable platform in the cloud can seamlessly accommodate any business large or small with no changes or customization to the platform codebase. Businesses with no existing systems can easily set up on the platform and one's with existing systems can use the platform for additional functionality.

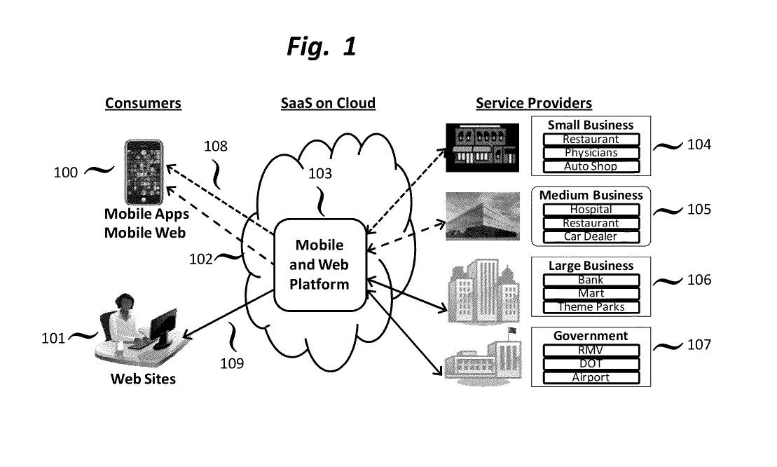

Referring now to the invention in more detail, FIG. 1 is an illustrative network architecture of the mobile-commerce and electronic-commerce platform. The network architecture shown in FIG. 1 depicts a variety of users and service providers with which the present invention may be deployed. For illustrative purposes we show two different types of users. It shows a mobile user 100 that is using a client Mobile Application or a Mobile Web Browser on a mobile device (e.g. iPhone, iPad, Android phone, Windows phone, etc.) and it shows an internet web user 101 using a Web Browser on a computer (e.g. desktop, laptop, etc.) to access the service status information that is maintained in the internet-based Cloud 102 by the Business Information and Service Status Management Mobile and Web Platform 103. The Cloud 102 in the FIG. 1 and other parts of this document refers to the services, computational resources, and storage resources, on the internet as provided by Cloud Service Providers. The platform 103 is used by service providers to publish information about their business and service status. The platform is very flexible and can support service providers of any size and service type. For example, Small Business 104 like Restaurant, Physician clinic, Auto Shop, etc.; Medium Business 105 like Hospital, Restaurant Chain, Car Dealer, etc.; Large Business 106 like Bank, Mart, Theme Parks, etc.; Government Public Sector Service Providers 107 like Registry of Motor Vehicle (RMV), Department of Transportation (DOT), Airport Security, etc.

In more detail, still referring to the invention of FIG. 1 shows illustrative examples of how the end-users 100 and 101 and the service providers 104, 105, 106, and 107, access the internet-based cloud services using dashed 108 or solid lines 109. The mobile user 100 or the service providers 104 and 105 access the services from the Cloud 102 via mobile telecommunications networks, as shown by the dashed lines 108. The internet web user 101 or the service providers 106 and 107 access the services from the Cloud 102 via land-line telecommunications networks (e.g. dial-up, broadband DSL, etc.) or cable networks (e.g. broadband cable-modem, etc.), as shown by the solid lines 109.

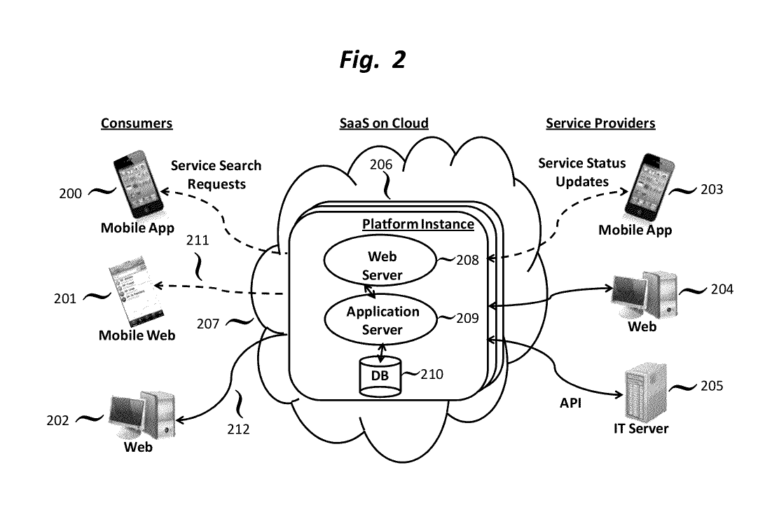

Referring now to the invention in more detail, FIG. 2 shows an illustrative Business Information and Service Status Information Management and Delivery Platform's system architecture according to the present invention. The system uses a client-server architecture with the server platforms running in the Cloud and/or on a compute and storage service.

The system comprises of various clients including but not limited to the ones shown in the FIG. 2. These application clients are of the following types
(1) Mobile App client 200 and 203 that is running on a mobile device like an iPhone, iPad, Android phone, Windows Phone, Blackberry, etc.
(2) Mobile Browser-based clients 201 like Safari, Chrome, etc. that is running on a device like an iPod Touch, Android tablets, Windows tablets, etc.
(3) Internet Browser-based clients 202 and 204 like Firefox, Internet Explorer, Safari, Chrome, Opera, etc. that is running on a computer like PCs, notebooks, netbooks, etc.
(4) Information Technology server 205 that has back-office software running on it that acts as a client making requests using an Application Programmatic Interface (API)

The Information Management Platform server consists of multiple software platform instances 206 running on a Cloud computing platform 207, like those provided by Amazon, Microsoft, Google, RackSpace, etc. The Cloud 207 gives the platform elasticity in terms of being able to increase the resources available for use, increasing the number of platform instances that can be run, redundancy in case one of the platform instance 206 fails, allows geographically distributed platform instances 206 for world-wide operations. Multiple software platform instances 206 are used for scalability to keep up with handling the number of client requests and are added as the number of client requests grow. The multiple instances 206 also provide redundancy and load-balancing. Redundancy is where if one of the platform instance 206 stops executing then the client requests are automatically redirected to the backup platform instance. Similarly for load-balancing the load-balance on the Cloud 207 will send requests to the least loaded platform instance 206 that is geographically closest to the client 200, 201, 202, 203, 204, and 205.

In more detail still referring to FIG. 2, the software architecture of the Information Management Platform instance 206 consists of a Web Server 208, an Application Server 209, and a Database System 210. The Web Server 208 handles all the incoming HTTP requests for services from the clients, 200, 201, 202, 203, 204, and 205. The Web Server 208 sends the HTTP requests for Services to the Application Server 209 for providing the actual service by executing the business logic as coded by the Application Server program. The Application Server 209 access data required for the business logic execution for the service by interfacing with the Database System 210. The Database System 210 can be any commercial off-the-shelf (COTS) system like MySQL, Oracle, Sybase, PostGress, etc.

In more detail, still referring to the invention of FIG. 2 shows illustrative examples of how the Consumer clients 200, 201, and 202, and the Service Provider clients 203, 204, and 205, access the internet cloud-based Software-as-a-Service (SaaS) server using dashed or solid lines. The mobile consumer 200 and 201 or the service provider 203 access the services from the cloud-based platform server 206 via mobile telecommunications networks, as shown by the dashed lines 211. The internet web user 202 or the service providers 204 and 205 access the services from the cloud-based platform server 206 via land-line telecommunications networks (e.g. dial-up, broadband DSL, etc.) or cable networks (e.g. broadband cable-modem, etc.), as shown by the solid lines 212.

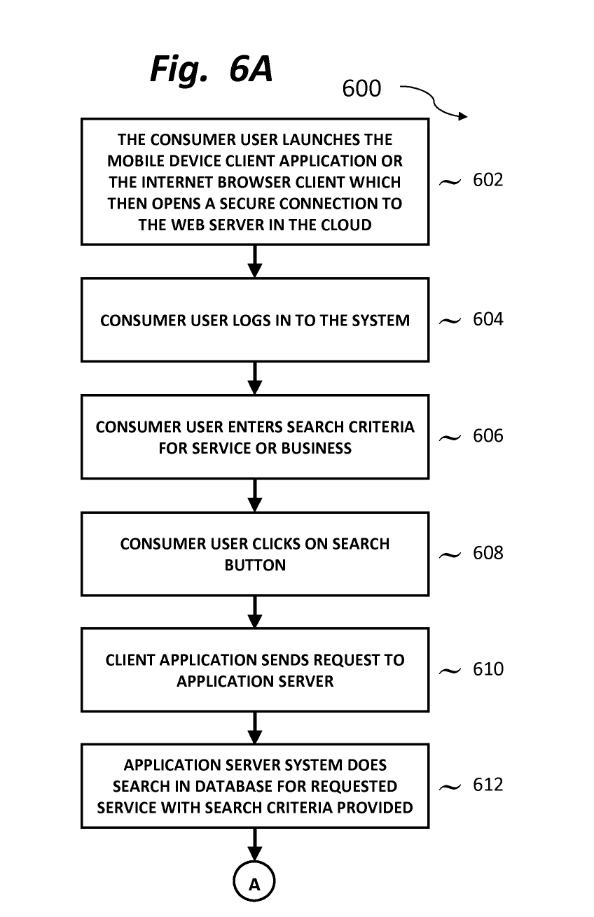

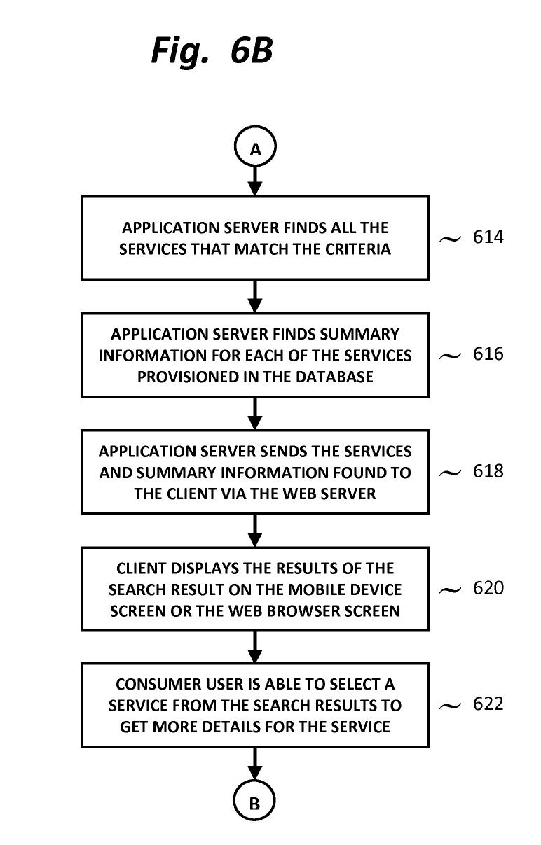

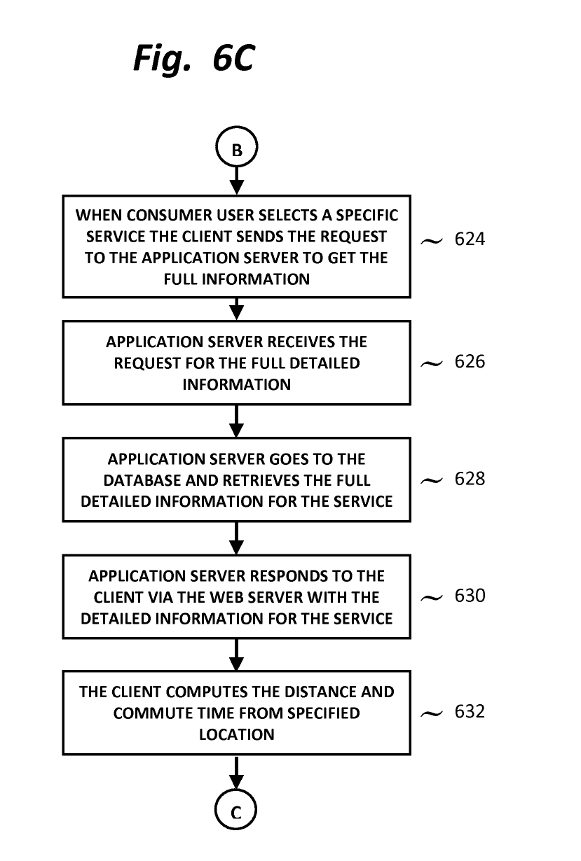

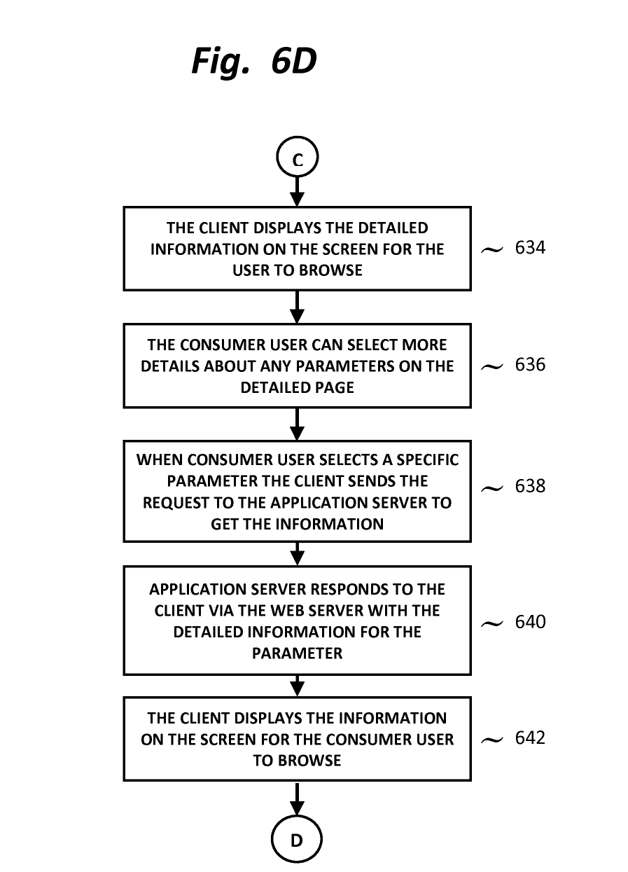

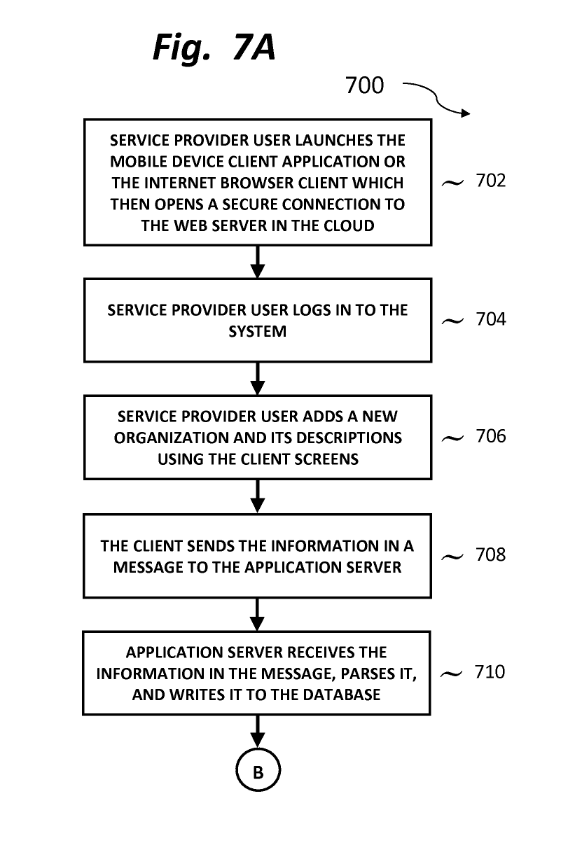

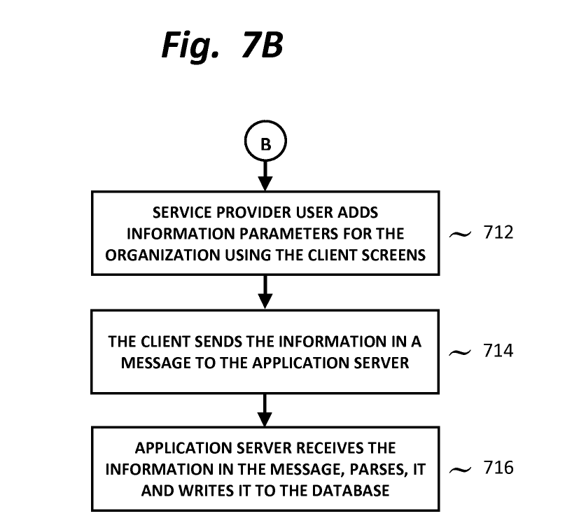

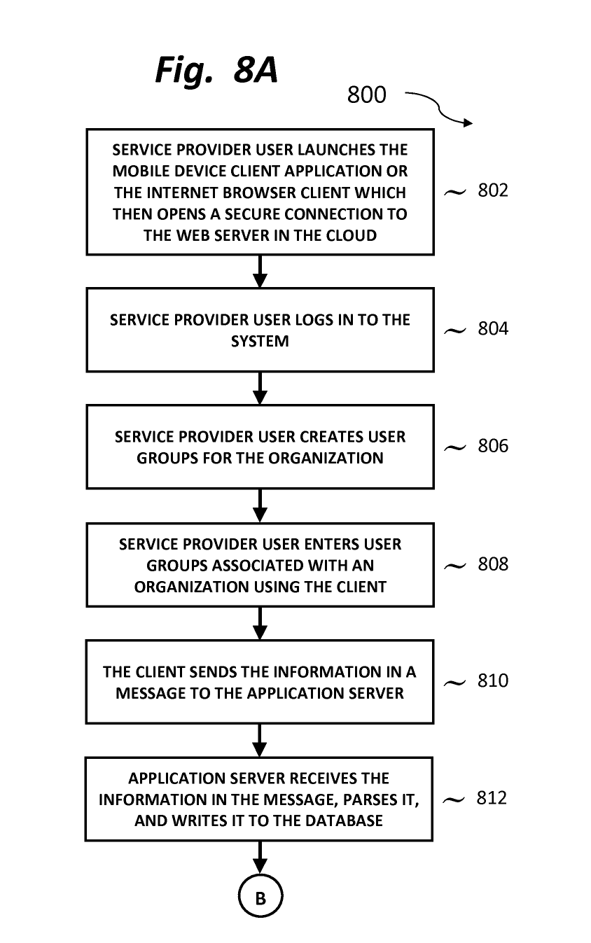

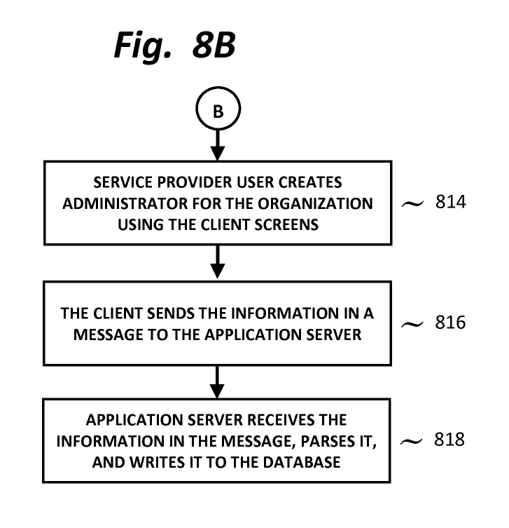

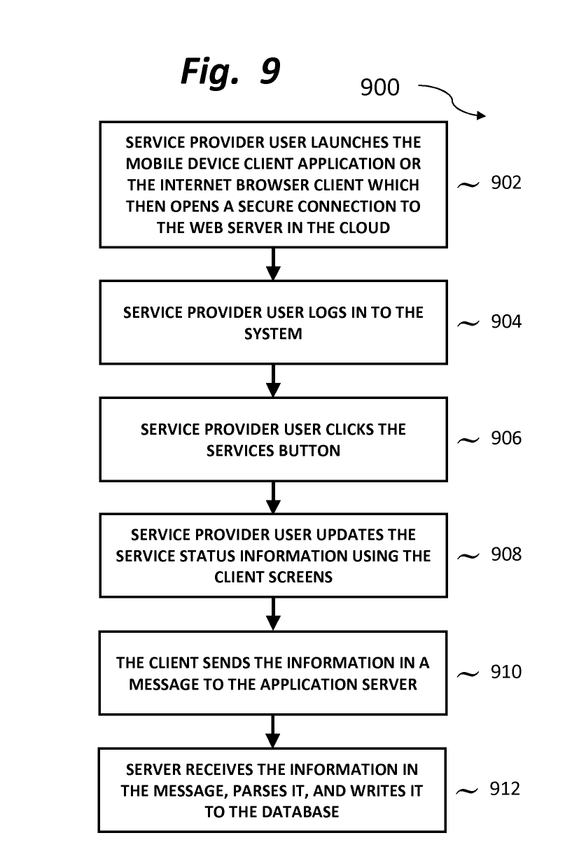

In more detail, still referring to the invention of FIG. 2, here we will briefly describe the general operations of the system. Additional detailed use case scenario operations are also described later as part of the descriptions for FIG. 6, FIG. 7, FIG. 8, and FIG. 9. It is to be appreciated that the invention is very flexible with generic design and its operations are not limited to what is described here and the use case scenarios described later in FIGS. 6, 7, 8, and 9. There are many more use case scenarios that the platform is capable of implementing due to its innovative design and implementations such that new services and their parameters, and use cases can be added very easily and rapidly. Referring to FIG. 2, a typical operation is as follows. A consumer user, as shown on the left hand side of the FIG. 2, will use the mobile device application client 200, mobile device web client 201, or computer-based web-browser client 202, provided by the system to access the service information from the platform 206. A service provider, as shown on the right hand side of the FIG. 2, will use the mobile device application client 203 provided by the system to access and update the service information on the platform. The platform 206, as shown in the middle of the FIG. 2, runs on the Internet Cloud 207 and provides the functionality for the consumer user and the service provider. A typical consumer user will search for a business, service, event, etc. via the mobile or computer-based client 200, 201, or 202. When the consumer initiates the search request the client 200, 201, or 202, software sends a request to the platform server 206 over the network 211 or 212 using a network communication protocol like HTTP that is not authenticated or encrypted or HTTPS that is secure, authenticated and encrypted. Note, other network communications can also be used for the client to server communications. The data being sent in the request from the client 200, 201, or 202, to the platform server 206 and the reply from the platform server 206 to the client 200, 201, or 202, can be encoded using techniques like JSON, XML, SOAP, etc. The platform 206 runs on the Cloud 207 and uses the resources like computing, memory, storage, etc. from the cloud. The request from the client 200, 201, or 202, software is received by the Web Server 208 on the platform instance. The Web Server 208 sends the request to the Application Server 209. The Application Server 209 provides the application logic to perform the appropriate operation requested by the client, like a search operation, get details about the selected service, get details about the selected organization information parameter, create or update an organization, create or update an organization information parameter, request a token from the business, provide a coupon, etc. During the processing of the request the Application Server 209 accesses data stored in the persistent storage Database 210. For processing the request the Application Server 209 may access other resources on the Cloud 207 like Google Maps™ for getting directions and commute time, Google AdSense for showing advertisements, Google Analytics for gathering statistics, Amazon Cloud Services, etc. After the Application Server 209 software logic completes performing operation it formulates the reply message. The reply message is then encoded using the technique mentioned previously like JSON, XML, SOAP, etc. The Application Server 209 then sends the reply back to the Web Server 208, which in turn sends the reply back to the appropriate consumer client 200, 201, or 202, software. The client-server interaction operations for the Service Provider client 203, 204, or 205, software follows the same method as described above for the Consumer client 200, 201, or 202.

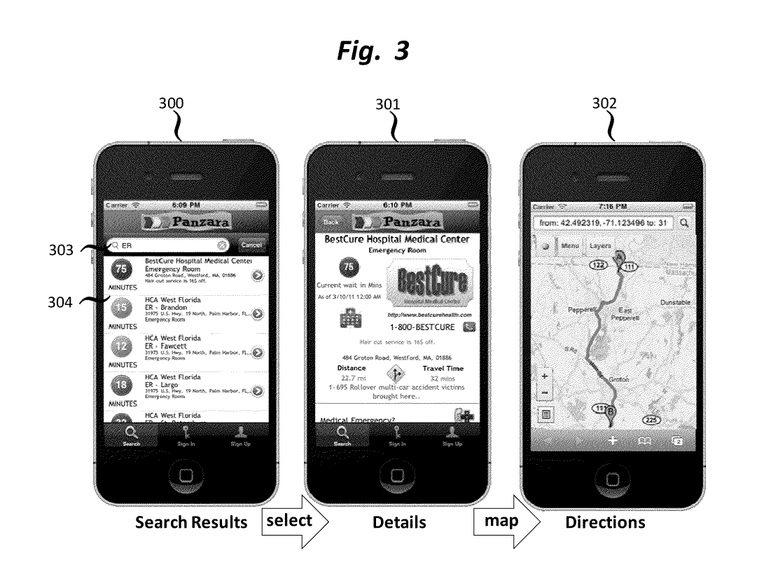

Referring now to the invention in more detail FIG. 3, are exemplary screens associated with certain of the Graphical User Interfaces (GUI) of the mobile application clients 200, 201, and 203, software. Some of the features of these screens will now be described. It is to be appreciated that these and other screens may be presented to the user on the screens of the mobile devices.

Particularly, FIG. 3 illustrates sample screens associated with the consumer 200 and 201 accessing the services to search for a business, service, or event, which is location-based. The screen shot 300 shows the search field 303 and the search results 304. The search field 303 allows the consumer to enter one or more key words to search for a business or service that they are interested in finding. The search results 304 show the list of businesses and service providers that match the keyword and are located near the consumer and the real-time dynamic status information for the business like wait-time, etc. For each business and service the result shows the business and service's status like wait-time, availability, etc. and information like address, phone number, etc. The most critical and real-time changing status information like wait-time and availability are shown in color-coded format with (1) red colored circle showing significant delay, (2) yellow-colored circle showing moderate delay, and (3) green-colored circle showing no delay. Note the color coding and circle shape for displaying the wait status are just one scheme, many other schemes could be used to display the wait-time or availability of the business or service status.

In more detail, still referring to the invention of FIG. 3 shows illustrative example of the detailed information screen 301 that is displayed when the consumer selects one of the businesses or services from the search results 304 on the summary screen 300. The detailed screen for a business or service displays all the attribute parameters that have been provisioned for the business or service by the service provided on the platform. In the illustrative screen 301 the various detailed parameters that are displayed are: (1) Business or Service name, (2) Business or service type, (3) address, phone number, etc. (4) distance to the service, travel time to the service, (5) the map button, (6) any other information attributes the business or service provide would like the consumer to see liked that has been provisioned in the platform by the service provider.

In more detail, still referring to the invention of FIG. 3 shows illustrative example of the map directions screen 302 that is displayed when the consumer selects the map button on the detailed screen 301.

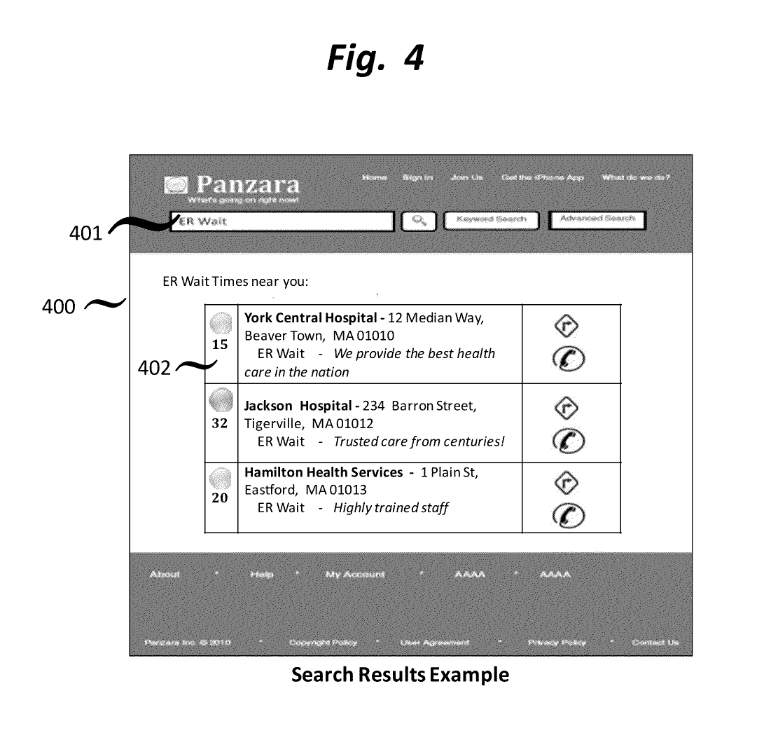

Referring now to the invention in more detail FIG. 4, is an exemplary screen associated with the Graphical User Interfaces (GUI) of the internet web browser-based application clients 202 and 205 software. Some of the features of this screen will now be described. It is to be appreciated that these and other screens may be presented to the user on the screens of the personal computer.

Particularly, FIG. 4 illustrates sample screen associated with the consumer 202 and service provider 204 accessing the services to search for a business, service, or event, which is location-based. The screen shot 400 shows the search field 401 and the search results 402. The search field 401 allows the consumer to enter one or more key words to search for a business or service that they are interested in finding. The search results 402 show the list of businesses and service providers that match the keyword and are located near the consumer and the real-time dynamic status information for the business like wait-time, etc. For each business and service the result shows the business and service's status like wait-time, availability, etc. and information like address, phone number, etc. The most critical and real-time changing status information like wait-time and availability are shown in color-coded format with (1) red colored circle showing significant delay, (2) yellow-colored circle showing moderate delay, and (3) green-colored circle showing no delay. Note the color coding and circle shape for displaying the wait status are just one scheme, many other schemes could be used to display the wait-time or availability of the business or service status can also be implemented.

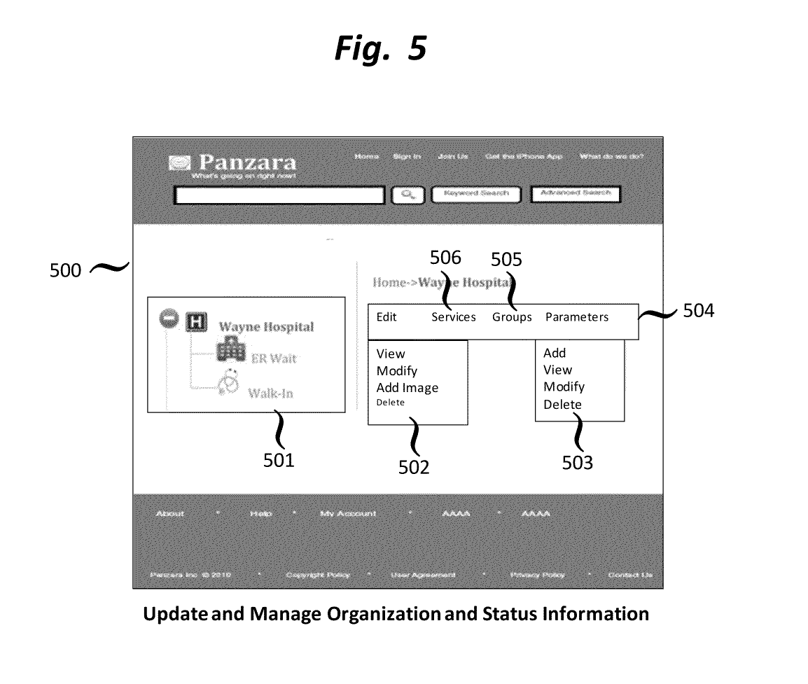

Referring now to the invention in more detail FIG. 5, is an exemplary screen associated with the Graphical User Interfaces (GUI) of the internet web browser-based application clients 202 and 205 software. Some of the features of this screen will now be described. It is to be appreciated that these and other screens may be presented to the user on the screens of the personal computer.

Particularly, FIG. 5 illustrates sample screen associated with the service provider 204 accessing the services to administrate the organization and update service status for a business, service, or event, which is location-based. The screen shot 500 shows the navigation tree 501 used by the service provider user to add and modify new services, groups, parameters, etc. 504. Also shown are sample menus to view, modify, add image, delete, etc. for Organization 502, Parameters 503, Groups 505, and Services 506.

The platform is very flexible and allows the service provider to add new business information, service status information parameters and loyalty programs very easily and generically. These are then shown in the Search results and the Detailed information pages on both the mobile device application clients as well as the internet web-browser based client.

Referring now to FIGS. 6A, 6B, 6C, and 6D, are showing a flow diagram illustrating an example scenario 600 of the operation of the service platform for the scenario in which a consumer user searches for a service or business, then obtains more details about the service, and then obtains more details about the service's parameter information. The elements of the flowchart 600 are described using the exemplary architecture described in FIG. 2, the mobile application screens described in FIG. 3, and the internet web-browser-based client screens described in FIG. 4. The operations proceed as follows. In step 602, the consumer user launches the mobile device client application (200 or 201) or the internet browser client (202) which then opens a secure connection to the Web server (208) in the cloud (207). In step 604, consumer user logs in to the system. In step 606, consumer user enters search criteria (303 or 401) for service or business. In step 608, the consumer user clicks on search button of the search field (303 or 401). In step 610, the client application (200, 201, or 202) sends request to Application server (209). In step 612, the Application server system (209) does search in database (210) for requested service with search criteria provided. In step 614, the Application server (209) finds all the services that match the criteria. In step 616, the Application server (209) finds summary information for each of the services provisioned in the database. In step 618, the Application server (209) sends the services and summary information found to the client application via the Web server (208). In step 620, client application (200, 201, or 202) displays the results of the search result (304 or 402) on the mobile device screen (200 or 201) or the web browser screen (202). In step 622, consumer user is able to select a service from the search results (304 or 402) to get more details for the service. In step 624, when consumer user selects a specific service the client application (200, 201, or 202) sends the request to the Application server (209) to get the full information. In step 626, the Application server (209) receives the request for the full detailed information. In step 628, the Application server (209) goes to the database (210) and retrieves the full detailed information for the service. In step 630, Application server (209) responds to the client application (200, 201, or 202) via the Web Server (208) with the detailed information for the service. In step 632, the client application (200, 201, or 202) computes the distance and commute time from specified location. In step 634, the client application (200, 201, or 202) displays the detailed information (301) on the screen for the consumer user to browse. In step 636, the consumer user can select more details about any parameters (301) on the detailed page. In step 638, when consumer user selects a specific parameter (301) the client application (200, 201, or 202) sends the request to the Application server (209) to get the information. In step 640, Application server (209) responds to the client application (200, 201, or 202) via the Web server (208) with the detailed information (302) for the parameter. In step 642, the client application (200, 201, or 202) displays the information (301) on the screen for the consumer user to browse.

Referring now to FIG. 7A and 7B is showing a flow diagram illustrating an example scenario 700 of the operation of the service platform for the scenario in which a service provider user creates a new organization and its related service information as parameters. The elements of the flowchart 700 are described using the exemplary architecture described in FIG. 2 and the internet web-browser-based client screens described in FIG. 5. The operations proceed as follows. In step 702, the service provider user launches the mobile device client application (203) or the internet browser client (204) which then opens a secure connection to the Web server (208) in the cloud (207). In step 704, the service provider user (203 or 204) logs in to the system. In step 706, the service provider user (203 or 204) adds a new organization (502) and its descriptions (503) using the client application screens (203 or 204). In step 708, the client application (203 or 204) sends the information in a message to the Application server (209).

In step 710, the Application server (209) receives the information in the message, parses it, and writes it to the database (210). In step 712, the service provider user (203 or 204) adds information parameters (503) for the organization using the client application screens (203 or 204). In step 714, the client application (203 or 204) sends the information in a message to the Application server (209). In step 716, the Application server (209) receives the information in the message, parses, it and writes it to the database (210).

Referring now to FIG. 8A and 8B is showing a flow diagram illustrating an example scenario 800 of the operation of the service platform for the scenario in which a service provider user creates user groups associated with an organization and the administrators for the organization. The elements of the flowchart 800 are described using the exemplary architecture described in FIG. 2 and the internet web-browser-based client screens described in FIG. 5. The operations proceed as follows. In step 802, the service provider user launches the mobile device client application (203) or the internet browser client application (204) which then opens a secure connection to the Web server (208) in the cloud (207).

In step 804, the service provider user (203 or 204) logs in to the system. In step 806, the service provider user (203 or 204) creates user groups for the organization (501). In step 808, the service provider user (203 or 204) enters user groups (505) associated with an organization (501) using the client (203 or 204). In step 810, the client application (203 or 204) sends the information in a message to the Application server (209). In step 812, the Application server (209) receives the information in the message, parses it, and writes it to the database (210). In step 814, the service provider user (203 or 204) creates administrator for the organization using the client application screens (203 or 204). In step 816, the client application (203 or 204) sends the information in a message to the Application server (209).

In step 818, the Application server (209) receives the information in the message, parses it, and writes it to the database (210).

Referring now to FIG. 9 is showing a flow diagram illustrating an example scenario 900 of the operation of the service platform for the scenario in which a service provider user updates the service status information. The elements of the flowchart 900 are described using the exemplary architecture described in FIG. 2 and the internet web-browser-based client screens described in FIG. 5. The operations proceed as follows.

In step 902, the service provider user launches the mobile device client application (203) or the internet browser client application (204) which then opens a secure connection to the Web server (208) in the cloud (207). In step 904, the service provider user (203 or 204) logs in to the system. In step 906, the service provider user (203 or 204) clicks the services button (506). In step 908, the service provider user (204 or 205) updates the service status information using the client application screens (203 or 204). In step 910, the client application (204 or 205) sends the information in a message to the Application server (209). In step 912, the Application server (209) receives the information in the message, parses it, and writes it to the database (210).

The advantages of the present invention include, without limitation, providing a generic and flexible location-based solution for consumers to access in one central place the dynamic real-time business and service status information and it provides the service providers a platform to publish their business and service status information. The platform has been implemented using an innovative and novel method that allows attribute parameters to be provisioned and configured by the service provider in a generic manner and with no or minimal software changes required. The platform is very flexible and allows the service provider from any vertical business markets to add new business information, service status information parameters, and loyalty programs very easily and generically. It allows for very easy and rapid addition of consumer and service provider use case scenarios. It is very highly scalable so it can be grown as the business usage increases, distributed world-wide to handle consumers and businesses all over the world with servers as close to them as possible, and redundancy to provide high availability.

In broad embodiment, the invention is a mobile-commerce and electronic-commerce information delivery platform that is a Consumer-to-Service Provider centric solution to effectively address the Service Status information that will benefit both the consumers and the service providers. The platform solution is a high availability Cloud based Software as a Service (SaaS) platform for a central and unified online site that provides an intuitive and simplified way for consumer to search for services and their real-time Service Status information using a mobile device or the web. The platform provides a highly efficient tracking mechanism of Service Status.

The service providers will publish the Service Status information and the consumer user will consume the Service Status. Similarly, the event organizers publish the event status and the invited group can be notified of the status information. Service providers will be able to provide real-time updates for consumers via web pages, mobile device applications, or via for their IT systems automatically via the Application Programmatic Interface (API).

Consumers will be able to go to one place, either the mobile device specific client applications for iPhone, iPad, Android, Blackberry, and Windows, or web pages to search for service providers within their area and with the shortest wait time.

This solution has several competitive advantages as the solution is being developed ground up. As a result, the solution is not ‘all-or-nothing’ deal; rather, consumer could adopt what they like best first and gradually embrace other features as they become aware of them. Similarly the service providers can get started with minimal effort because the platform solution is on the Cloud.

Once adopted, this solution will become a way of life for people and businesses involved because even a small subset of the functionality of the solution will be invaluable tool for large number of people.

Some of the additional information management areas the platform supports in a generic way that can be used by any service provider comprise of:
1) Service Status Management: Service Status real-time information like wait and availability information.
2) Loyalty Programs Management: Service provider able to reward loyal customers using various schemes comprising of:
   a) Punch Cards: Service provider able to provide punch cards like buy a certain number and get one or more free.
   b) Points Cards: Service provider able to point cards like collect certain amount of points and get certain amount of dollars for purchasing.
   c) Coupon Management: Service provider able to provide coupons based on time, targeted audience.
3) Store card Management: Service provider is able to manage and keep track online of store frequent purchaser cards.
4) Token Management: Service providers like Banks, Restaurants, RMV, etc. use tokens/tickets/buzzers for servicing consumers in the queue.

Note, that above are just a few illustrative examples, the platform being generic in nature can support many other functionalities that are too numerous to list exhaustively here.

Some of the functions provided by the platform comprise of:
(1) Effective search mechanism to find services and events of interest using various search criteria.
(2) Selection and interact with the services among the services found.
(3) Request services of interest in order for the respective service offering parties to respond easily. The system can perform matching of services and if found, the results are forwarded to requesting parties.
(4) Publishing of services offered so that the interested consumers could easily find them.
(5) Loyalty programs management so that the interested consumers could easily find and subscribe to them.
(6) Customer marketing management so that the business service provider could easily categorize customers in to user groups and target them for rewards and notifications.
(7) Uniform interface making the usage of the system easier across all the applications.
(8) Business intelligence queries across wide array of user activities and interests.
(9) Report generation specific to individuals or organizations related to such things as trends.
(10) History recall and accounting for various activities eliminating mundane overheads.
(11) Social networking with a service oriented purpose.
(12) Location based services so the system is equally effective when the users or their service locations change. The system can identify consumers or producers based on specific locations.
(13) E-commerce by providing reliable and secure transactions as needed.

Note, that above are just a few illustrative examples, the platform being generic in nature can support many other functionalities that are too numerous to list exhaustively here.

Some of the markets that the platform can be used for are comprised of:

| | | |
|---|---|---|
| Hospitals | Restaurants | Banks |
| Healthcare centers | Enterprises | Group events |
| Hair cutting salons | Bill pay at counters | Games, sports |
| Theme parks | Airports | Government centers |
| Bus & train stations | Movie theatre | Hotels & Motels |
| Car washes | Car Dealerships | Individual events |

Note, that above are just a few illustrative examples, the platform being generic in nature can support many other markets that are too numerous to list exhaustively here.

While each benefit of the platform may have some competing solutions in the market there is no single application that can match the functionality of this platform. Even the combined benefit of several applications will come short of the benefits offered by the platform because it has new, unique, and non-obvious combination.

The platform with its generic and scalable platform in the Cloud can seamlessly accommodate any business large or small with no changes or customization to the platform codebase. Businesses with no existing systems can easily set up on the platform and one's with existing systems can use the platform for additional functionality.

It is to be appreciated that the above-described screens are merely exemplary in nature and that the system may include other screens used to perform portions of the various methodologies described herein.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods and that various other changes and modifications may be affected therein by one skilled in the art within the scope and spirit of the invention.

What is claimed is:

1. A system for managing delivery of a business information, a real-time dynamic service status information, and/or a real-time dynamic event status information, of a one or more services by a one or more service providers to a one or more consumers by a general purpose electronic commerce and/or information management platform system, the system comprising of:
a one or more processing devices operative to:
(i) provision and/or publish the business information;
(ii) provision and/or publish the real-time dynamic service status information;
(iii) provision and/or publish a real-time dynamic event status information;
(iv) provision, publish, and/or manage a one or more of the loyalty programs comprising of a punch cards, a loyalty cards, a points cards, a discount coupons and/or a store rewards card;
(v) provision, publish, and/or manage a one or more deals comprising of the punch cards, the loyalty cards, the points cards, the discount coupons, and/or the store rewards cards;
(vi) manage a one or more customer marketing programs;
(vii) manage a one or more reservations online for the services;
(viii) manage a one or more tokens for the services;
(ix) search for a one or more businesses;
(x) search for an information comprising of the business information, the real-time dynamic service status, the real-time dynamic event status, the deals, the deals, the loyalty programs, and/or the customer marketing programs;
(xi) search for the information comprising of the business information, the real-time dynamic service status, the real-time dynamic event status, the deals, the loyalty programs, and/or the customer marketing programs, using a mobile device and/or a computer;
(xii) search for the information comprising of the business information, the real-time dynamic service status, the real-time dynamic event status, the deals, the deals, the loyalty programs, and/or the customer marketing programs, based on a geo-location;
(xiii) organize one or more of the punch cards, the loyalty cards, the points cards, the discount coupons, and/or the store rewards cards, in an electronic mobile and/or computer wallet organizer;
(xiv) send the information comprising of the business information, the real-time dynamic service status, the real-time dynamic event status, the deals, the loyalty programs, and/or the customer marketing programs, to a one or more social networks; and
(xv) a memory, coupled to the one or more processing devices, which stores one or more of a portion of data and program associated with the provisioning, publishing, managing, and/or searching operations in a generic, configurable, and extensible manner for services and/or information comprising of: the business information, the real-time dynamic service status, the real-time dynamic event status, the deals, the loyalty programs, and/or the customer marketing programs.

2. The system of claim 1, wherein at least one of the processing devices comprises of a client device and at least one of the processing device comprises of a server, the client device and the server can be coupled via a communications network.

3. The system of claim 2, wherein the client device comprises of: a mobile device, a tablet, a personal computer, a laptop computer, a computer, a device capable of running web browsers, and/or a device capable of running applications, that can be at a location associated with the consumer and/or the service provider.

4. The system of claim 2, wherein the server can be resident at a location associated with a provider of the compute and/or storage service.

5. The system of claim 2, wherein the communications network can be any type of data communications network or telecommunications network.

6. The system of claim 1, wherein the one or more processing devices are further operative to allow the service provider to provision and/or publish the business information.

7. The system of claim 1, wherein the one or more processing devices are further operative to allow the service provider to do operations comprising of: manage an account; manage a profile, configure the business information, publish the real-time dynamic service status information, publish the real-time dynamic event status updates, publish the real-time dynamic service status updates, publish an announcement, manage the deals, manage the loyalty programs, manage the customer marketing programs, take the online reservations for services, and/or send the business information to the social networks.

8. The system of claim 1, the one or more processing devices are further operative to allow the service provider to manage the loyalty programs and/or the deals comprising of electronic and/or paper versions of: the punch cards; the points cards; the discount coupons; and/or the store rewards cards.

9. The system of claim 1, wherein the one or more processing devices are further operative to allow the service provider to manage the customer marketing programs comprising of the service provider using a client device to set up the one or more consumer categories to award different rewards based on the consumer's loyalty and/or frequency of visiting the business.

10. The system of claim 1, wherein the one or more processing devices are further operative to allow the consumer to do operations comprising of: configure an account, manage a personal profile, search for the business information, search the real-time dynamic service status, search the real-time dynamic event status updates, search the service status updates, search for the deals, search for the loyalty programs, search for the customer marketing programs, subscribe for the business information, subscribe for the announcements, subscribe for the deals, subscribe for the loyalty programs, subscribe for the customer marketing programs, manage the deals, manage the loyalty programs, manage the customer marketing programs, manage the electronic mobile and/or computer wallet organizer, make the online reservations for the services, and/or send the business information to the social networks.

11. The system of claim 1, wherein the one or more processing devices are further operative to allow the consumer using a client device to show the service provider the electronic and/or paper versions of the service provider's the loyalty programs and/or the deals to manage award or subtract points, punches, or discounts on the card.

12. A computer-implemented method for delivery of a business information, a real-time dynamic service status information, and/or a real-time dynamic event status information, of a one or more services by a one or more service providers to a one or more consumers by a general purpose platform system, the steps for the service provider comprising of:
provision and/or publish an information comprising of the business information, the real-time dynamic service status information, the real-time dynamic event status information, a or more deals, a one or more loyalty programs, and/or a customer marketing program.
manage a services comprising of an online reservations, a tokens for the services, the deals, the loyalty programs, and/or the customer marketing program;
manage to award or subtract at least punches, points, and/or discounts on an electronic and/or paper loyalty program card of the consumer; and
send the information comprising of the business information, the real-time dynamic service status, the real-time dynamic event status, the deals, the loyalty programs, and/or the customer marketing programs, to a one or more social networks.

13. A computer-implemented method for delivery of a business information, a real-time dynamic service status information, and/or a real-time dynamic event status information, of a one or more services by a one or more service providers to a one or more consumers by a general purpose platform system, the steps for the consumer comprising of:
search for a one or more businesses;
search and/or subscribe for an information comprising of the business information, the real-time dynamic service status, the real-time dynamic event status, a one or more deals, a one or more loyalty programs, and/or a customer marketing program;
manage a services comprising of an online reservations, a tokens for the services, the deals, the loyalty programs, and/or the customer marketing programs;
manage a one or more of the loyalty programs comprising of a punch cards, a loyalty cards, a discount coupons, and/or a store rewards cards, in an electronic mobile and/or computer wallet organizer;
manage an award or subtract a one or more of punches, points, and/or discounts on an electronic and/or paper loyalty program card of the consumer; and
send the information comprising of the business information, the real-time dynamic service status, the real-time dynamic event status, the deals, the loyalty programs, and/or the customer marketing programs, to a one or more social networks.

14. A system for managing delivery of a business information, a real-time dynamic service status information, and/or a real-time dynamic event status information, of a one or more services by a one or more service providers to a one or more consumers by a general purpose platform system, the system comprising of:
a one or more processing devices to:
(i) a first means of provisioning and/or publishing an information comprising of the service status information, the event status information, and/or the business information;
(ii) a second means of managing the information comprising of the service status information, the event status information, and/or the business information;
whereby the service providers using the said first means can provision and/or manage the information comprising of the services status information, the event status information, and/or the business information;
whereby the consumers using the said second means can search the information comprising of the service status information, the event status information and/or the business information; and
whereby the service provider using the said first means can manage the one or more services.

15. The system of claim 14, wherein the one or more processing devices are further operative to allow the service provider to do operations comprising of: publish the real-time dynamic service status information; and/or publish the business information.

16. The system of claim 14, the one or more processing devices are further operative to allow the service provider to manage a one or more of a deals and/or a loyalty programs.

17. The system of claim 14, wherein the one or more processing devices are further operative to allow the service provider to manage a one or more customer marketing programs.

18. A computer-implemented method for delivery of a business information, a real-time dynamic service status information, and/or a real-time dynamic event status information, of a one or more services by a one or more service providers to a one or more consumers by a general purpose platform system, the steps comprising of:
provisioning and/or publishing an information comprising of the service status information, the event status information, the business information, a deals, a loyalty program, and/or a customer marketing program;
managing the information comprising of the service status information, the event status information, the business information, the deals, the loyalty program, and/or the customer marketing program;
whereby the service providers can provision and/or manage the information comprising of the services status information, the event status information, the business information, the deals, the loyalty program, and/or the customer marketing program; and
whereby the service provider can manage the one or more services.

19. A computer-implemented method for delivery of a business information, a real-time dynamic service status information, and/or a real-time dynamic event status information, of a one or more services by a one or more service providers to a one or more consumers by a general purpose platform system, the steps comprising of:
search and/or subscribe for an information comprising of the service status information, the event status information, the business information, a deals, a loyalty program, and/or a customer marketing program;
whereby the consumers can search the information comprising of the service status information, the event status information, the business information, the deals, the loyalty program, and/or the customer marketing program; and
whereby the consumer can manage the one or more services.
